(19) United States
(12) Patent Application Publication
(10) Pub. No.: US 2004/0032323 A1
(43) Pub. Date: Feb. 19, 2004

(54) Detection apparatus

(76) Inventor: Daniel Nommensen, Monroe, WI (US)

Correspondence Address: DAVID J. ARCHER, 9790 Forest Pres. RD, DURAND, IL, 61024, US

(21) Appl. No.: 10/215,284

(22) Filed: Aug. 8, 2002

(51) Int. Cl. B60Q 1/00

(52) U.S. Cl. 340/440; 340/666

(57) ABSTRACT

A detection apparatus is disclosed for detecting an overloaded condition of a truck. The apparatus includes a first arm which has a first and a second end, the first end of the first arm being rigidly secured to a frame of the truck. A portion of a proximity detector is fixedly secured to the second end of the first arm. A second arm has a first and a second extremity, the first extremity of the second arm being connected to a suspension of the truck. A further portion of the proximity detector is fixedly secured to the second extremity of the second arm. The further portion is disposed in a vicinity of the portion such that when the truck is loaded, the portion and further portion move towards each other and so that when the overloaded condition of the truck is reached, the portion and the further portion are disposed adjacent to each other. An electrical circuit is triggered when the portion and the further portion are disposed adjacent to each other. Also, a warning device is electrically connected to the circuit such that when the circuit is triggered, the warning device is actuated.

### BACKGROUND OF THE INVENTION

1. Field of the Invention

The present invention relates to a detection apparatus for detecting an overloaded condition of a truck. More particularly, the present invention relates to a magnetic proximity detection apparatus for detecting an overloaded condition of a truck.

2. Background Information

Large home improvement stores often provide a rental truck so that customers can transport building supplies from the store to the improvement site. However, there is a strong tendency for such customers to grossly overload such rental truck. Such overloading of the rental truck poses a potentially serious transportation hazard.

The present invention overcomes the aforementioned transportation problem by the provision of a magnetic proximity detector disposed in the vicinity of the truck suspension so that a portion of the detector secured to a leaf spring of the truck moves towards a complementary portion of the proximity detector attached to the frame of the truck. When the truck is overloaded, the portion and complementary portion are disposed adjacent to each other so that an electrical circuit is triggered by the adjacent portions for setting off an alarm. However, for safety reasons, an inhibitor switch is incorporated into the circuit so that the alarm is only actuated when the truck is parked with the transmission in park. Nevertheless, the alarm will be actuated in park when the engine is running or when the engine is switched off.

Therefore, it is a primary feature of the present invention to provide a detection apparatus that overcomes the problems associated with the prior art arrangements.

Another feature of the present invention is the provision of a detection apparatus that deters customer from overloading a rental truck.

Other features and advantages of the present invention will be readily apparent to those skilled in the art by a consideration of the detailed description of a preferred embodiment of the present invention contained herein.

### SUMMARY OF THE INVENTION

The present invention relates to a detection apparatus for detecting an overloaded condition of a truck. The apparatus includes a first arm which has a first and a second end, the first end of the first arm being rigidly secured to a frame of the truck. A portion of a proximity detector is fixedly secured to the second end of the first arm. A second arm has a first and a second extremity, the first extremity of the second arm being connected to the suspension of the truck. A further portion of the proximity detector is fixedly secured to the second extremity of the second arm. The further portion is disposed in a vicinity of the portion such that when the truck is loaded, the portion and further portion move towards each other and so that when the overloaded condition of the truck is reached, the portion and the further portion are disposed adjacent to each other. An electrical circuit is triggered by the proximity detector when the portion and the further portion are disposed adjacent to each other. Also, a warning device is electrically connected to the circuit such that when the circuit is triggered, the warning device is actuated.

In a more specific embodiment of the present invention, the first arm includes a first section which extends from the first end of the first arm. A second section extends from the first section to the second end of the first arm.

The first section defines a hole and the first arm includes a fastener which extends through the hole for fastening the first section to the frame of the truck.

Also, the second section supports the portion of the proximity detector and the portion of the proximity detector is welded to the second section.

Additionally, the second section extends angularly from the first section.

More specifically, the portion of the proximity detector includes a peripheral wall which is of circular configuration, the wall being welded to the second end of the first arm.

Moreover, the wall includes a first weld and a second weld which is disposed diametrically opposite to the first weld such that the weld secures the portion of the proximity detector to the second end of the first arm.

The second arm include a first member which extends from the first extremity of the second arm. Also, a second member extends from the first member to the second extremity of the second arm.

Additionally, the first member defines a bore and the second arm includes a fastening device which extends through the bore for connecting the first member to the suspension of the truck.

Furthermore, the second member supports the further portion of the proximity detector. Also, the further portion of the proximity detector is welded to the second member.

The second member extends normal from the first member. Additionally, the further portion of the proximity detector includes a peripheral casing which is of circular configuration. The casing is welded to the second extremity of the second arm.

More particularly, the casing includes a first welding and a second welding which is disposed diametrically opposite to the first welding such that the weldings secure the further portion of the proximity detector to the second extremity of the second arm.

In a preferred embodiment of the present invention, the proximity detector is a magnetic detector.

Moreover, the apparatus further includes a saddle bracket which is secured to the first extremity of the second arm. The saddle bracket includes a first part which cooperates with the suspension of the truck. A second part of the bracket is fastened to the first part such that the parts extend around and are clamped to the suspension of the truck.

The apparatus further includes a first magnetic device which is disposed within the portion of the proximity detector. A second magnetic device is disposed within the further portion of the proximity detector such that when the portion and the further portion are disposed adjacent to each other, the magnetic devices react relative to each other for triggering the electrical circuit.

In one embodiment of The present invention, the warning device includes an audible alarm for deterring a user from overloading the truck.

However, in an alternative embodiment of the present invention, the warning device includes a visual alarm for deterring a user from overloading the truck.

The apparatus also includes an inhibitor device which is electrically connected to the electrical circuit such that when the electrical circuit is triggered, the warning device is only electrically connected to the circuit when the truck is parked.

Also, the apparatus further includes a third arm which has a first and a second end, the first end of the third arm being rigidly secured to the frame of the truck. A portion of a further proximity detector is fixedly secured to the second end of the third arm. A fourth arm has a first and a second extremity, the first extremity of the fourth arm being connected to the suspension of the truck on an opposite side of the truck so that the proximity detector and further proximity detector are located on a first and a second side respectively of the truck. A further portion of the further proximity detector is fixedly secured to the second extremity of the fourth arm. The further portion is disposed in a vicinity of the portion such that when the truck is loaded, the portion and further portion move towards each other and so that when the overloaded condition of the truck is reached, the portion and the further portion are disposed adjacent to each other. The electrical circuit is triggered when the portion and the further portion of the proximity detector are disposed adjacent to each other and when the portion and the further portion of the further proximity detector are disposed adjacent to each other. The arrangement is such that the circuit is triggered regardless of a disposition of an overload relative to the sides of the truck.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

Although, throughout the present application, reference is made to a “rental truck” and the user thereof being a “customer”, it will be understood by those skilled in the art that the concept of the present invention is also applicable to any type of truck and the user thereof.

### BRIEF DESCRIPTION OF THE DRAWINGS

FIG. 1 is a side elevational view of a detection apparatus according to the present invention for detecting an overloaded condition of a truck;

FIG. 2 is an enlarged fragmentary view of the apparatus shown in FIG. 1;

FIG. 3 is a similar view to that shown in FIG. 2 but shows the truck being loaded with a load L;

FIG. 4 is a view similar to that shown in FIG. 1 but illustrating the attitude of the truck when being loaded as shown in FIG. 3.

FIG. 5 is a similar view to that shown in FIG. 3 but shows the truck being loaded with an overload L;

FIG. 6 is a similar view to that shown in FIG. 1 but shows the truck in the overloaded condition.

FIG. 7 is an enlarged view of the first arm;

FIG. 8 is an enlarged view of the second arm;

FIG. 9 is a similar view to that shown in FIG. 7 but shows a detector on the opposite side of the truck; and

FIG. 10 is a similar view to that shown in FIG. 8.

Similar reference characters refer to similar parts throughout the various views and embodiments of the drawings.

### DETAILED DESCRIPTION OF THE DRAWINGS

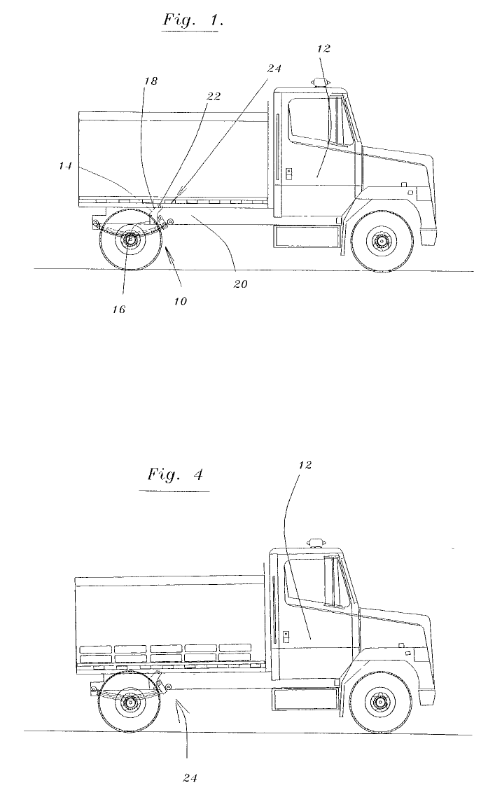

FIG. 1 is a side elevational view of a detection apparatus generally designated 10 according to the present invention for detecting an overloaded condition of a truck 12. The apparatus 10 includes a first arm 14 which has a first and a second end 16 and 18 respectively, the first end 16 of the first arm 14 being rigidly secured to a frame 20 of the truck 12. A portion 22 of a proximity detector generally designated 24 is fixedly secured to the second end 18 of the first arm 14.

FIG. 2 is an enlarged fragmentary view of the apparatus 10 shown in FIG. 1. As shown in FIG. 2, a second arm 26 has a first and a second extremity 28 and 30 respectively, the first extremity 28 of the second arm 26 being connected to a suspension generally designated 32 of the truck 12. A further portion 34 of the proximity detector 24 is fixedly secured to the second extremity 30 of the second arm 26.

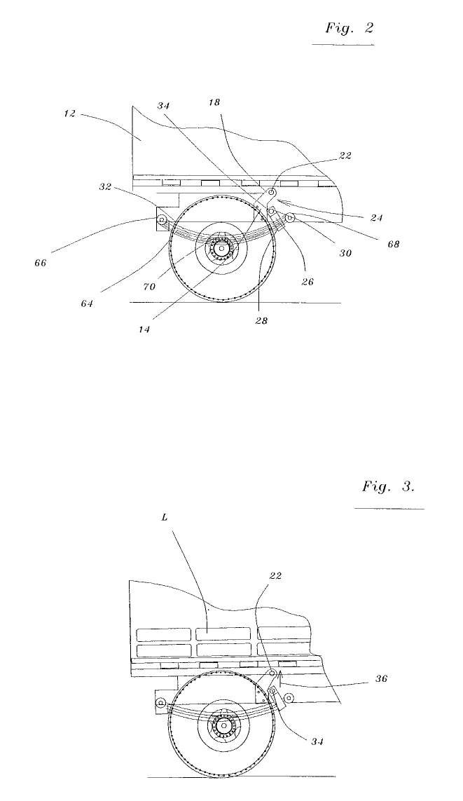

FIG. 3 is a similar view to that shown in FIG. 2 but shows the truck 12 being loaded with a load L. As shown in FIG. 3, the further portion 34 is disposed in a vicinity of the portion 22 such that when the truck 12 is loaded as indicated by the load L, the portion 22 and further portion 34 move towards each other as indicated by the arrow 36.

FIG. 4 is a view similar to that shown in FIG. 1 but illustrating the attitude of the truck 12 when being loaded as shown in FIG. 3.

FIG. 5 is a similar view to that shown in FIG. 3 but shows the truck 12 being loaded with, an overload L. As shown in FIG. 5, when the overloaded condition of the truck 12 is reached, the portion 22 and the further portion 34 are disposed adjacent to each other. An electrical circuit generally designated 38 is triggered when the portion 22 and the further portion 34 are disposed adjacent to each other. Also, a warning device 40 is electrically connected to the circuit 38 such that when the circuit 38 is triggered, the warning device 40 is actuated.

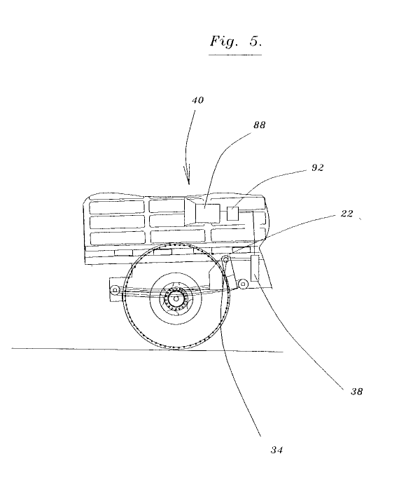

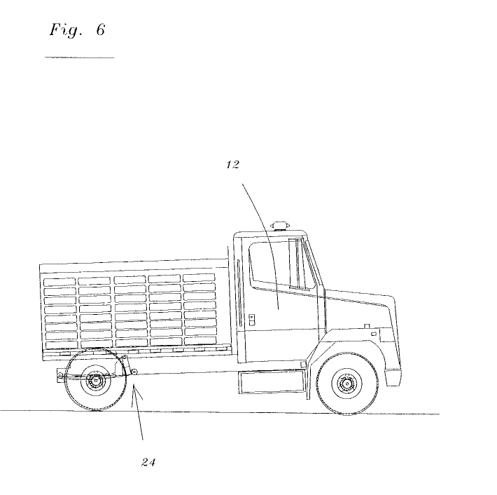

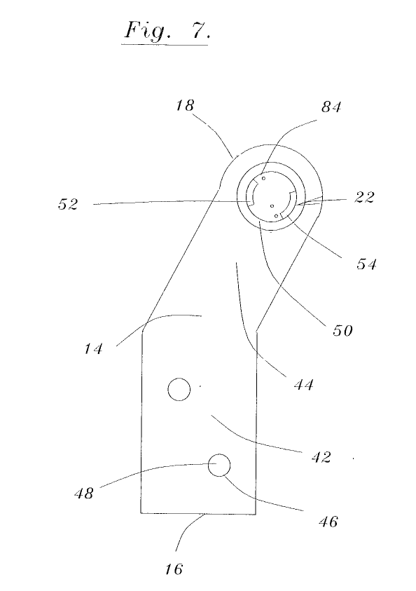

FIG. 6 is a similar view to that shown in FIG. 1 but shows the truck in the overloaded condition.

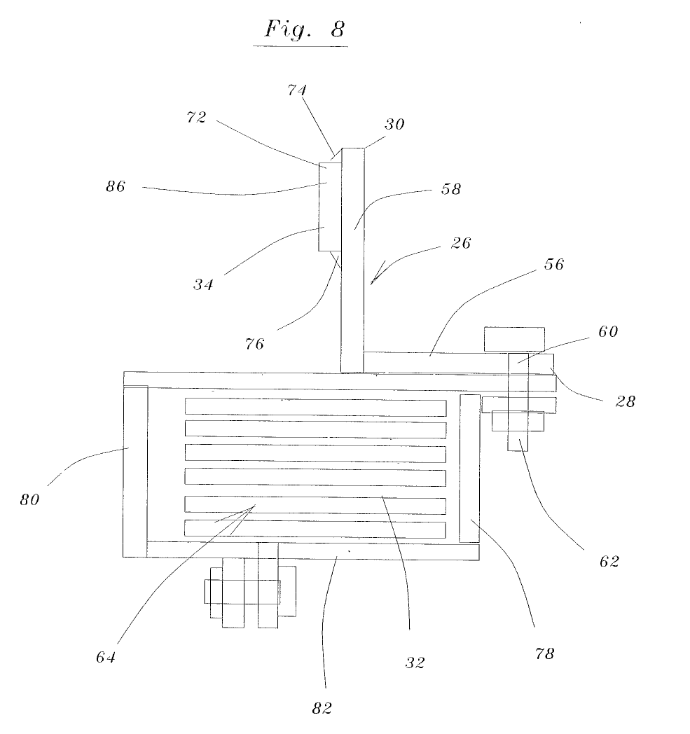

FIG. 7 is an enlarged view of the first arm 14. As shown in FIG. 7, the first arm 14 includes a first section 42 which extends from the first end 16 of the first arm 14. A second section 44 extends from the first section 42 to the second end 18 of the first arm 14.

The first section 42 defines a hole 46 and the first arm 14 includes a fastener 48 which extends through the hole 46 for fastening the first section 42 to the frame 20 of the truck 12.

Also, the second section 44 supports the portion 22 of the proximity detector 24 and the portion 22 of the proximity detector 24 is welded to the second section 44.

Additionally, the second section 44 extends angularly from the first section 42.

More specifically, the portion 22 of the proximity detector 24 includes a peripheral wall 50 which is of circular configuration and the wall 50 is welded to the second end 18 of the first arm 14.

Moreover, the wall 50 includes a first weld 52 and a second weld 54 which is disposed diametrically opposite to the first weld 52 such that the welds 52 and 54 secure the portion 22 of the proximity detector 24 to the second end 18 of the first arm 14.

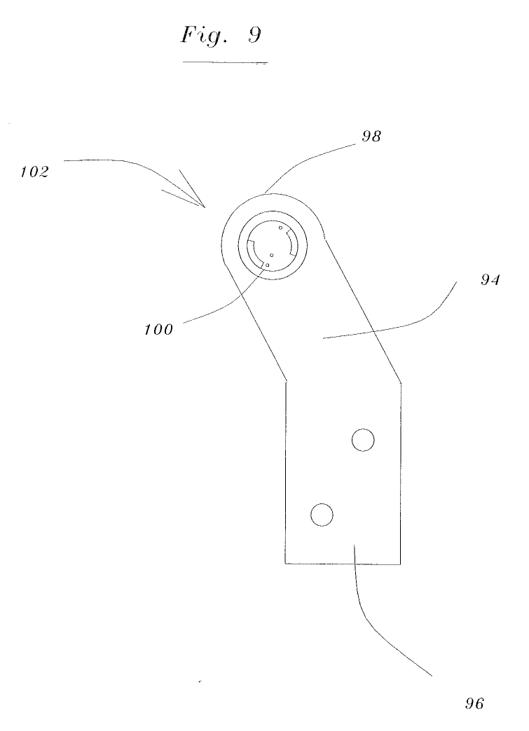

FIG. 8 is an enlarged view of the second arm 26. As shown in FIG. 8, the second arm 26 includes a first member 56 which extends from the first extremity 28 of the second arm 26. Also, a second member 58 extends from the first member 56 to the second extremity 30 of the second arm 26.

Additionally, the first member 56 defines a bore 60 and the second arm 26 includes a fastening device generally designated 62 which extends through the bore 60 for connecting the first member 56 to the suspension 32 of the truck 12.

As shown in FIG. 2, the suspension as shown is a multi-leaf spring generally designated 64 with a first and second shackle 66 and 68 respectively and an axle anchor 70 disposed between the shackles 66 and 68.

As shown in FIG. 8, the second member 58 supports the further portion 34 of the proximity detector 24. Also, the further portion 34 of the proximity detector 24 is welded to the second member 58.

The second member 58 extends normal from the first member 56. Additionally, the further portion 34 of the proximity detector 24 includes a peripheral casing 72 which is of circular configuration. The casing 72 is welded to the second extremity 30 of the second arm 26.

More particularly, the casing 72 includes a first welding 74 and a second welding 76 which is disposed diametrically opposite to the first welding 74 such that the weldings 74 and 76 secure the further portion 34 of the proximity detector 24 to the second extremity 30 of the second arm 26.

In a preferred embodiment of the present invention, the proximity detector 24 is a magnetic detector.

Moreover, the apparatus 10 further includes a saddle bracket generally designated 78 which is secured to the first extremity 28 of the second arm 26. The saddle bracket 78 includes a first part 80 which cooperates with the suspension 32 of the truck 12. A second part 82 of the bracket 78 is fastened to the first part 80 such that parts 80 and 82 extend around and are clamped to the suspension 32 of the truck 12.

As shown in FIG. 7, the apparatus 10 further includes a first magnetic device 84 which is disposed within the portion 22 of the proximity detector 24. Also, as shown in FIG. 8, a second magnetic device 86 is disposed within the further portion 34 of the proximity detector 24 such that when the portion 22 and the further portion 34 are disposed adjacent to each other, the magnetic devices 84 and 86 react relative to each other for triggering the electrical circuit 36.

In one embodiment of the present invention, the warning device 40 includes an audible alarm 88 for deterring a user from overloading the truck 12.

However, in an alternative embodiment of the present invention, the warning device 40 includes a visual alarm 90 for deterring a user from overloading the truck 12.

As shown in FIG. 5, the apparatus 10 also includes an inhibitor device 92 which is electrically connected to the electrical circuit 36 such that when the electrical circuit 36 is triggered, the warning device 40 is only electrically connected to the circuit 36 when the truck 12 is parked.

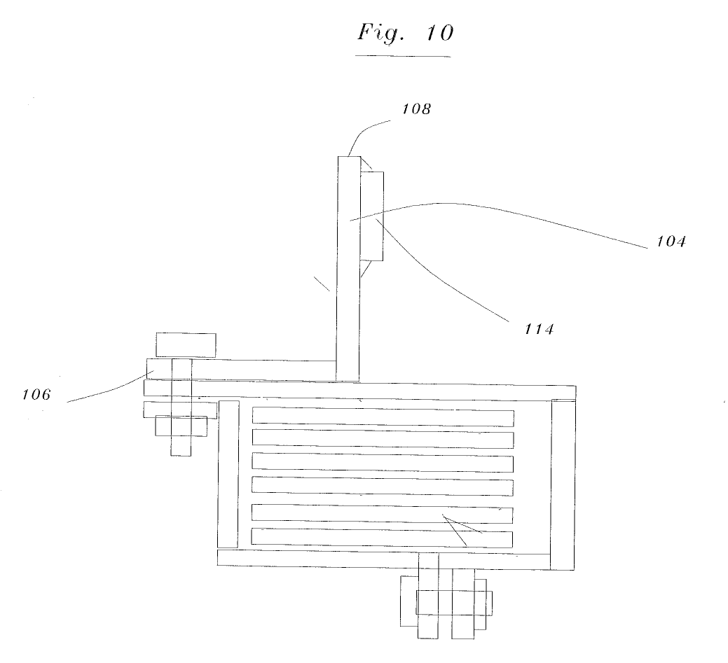

FIG. 9 is a similar view to that shown in FIG. 7 but shows a detector on the opposite side of the truck. As shown in FIG. 9, the apparatus 10 further includes a third arm 94 which has a first and a second end 96 and 98 respectively, the first end 96 of the third arm 94 being rigidly secured to the frame 20 of the truck 12. A portion 100 of a further proximity detector 102 is fixedly secured to the second end 98 of the third arm 94.

FIG. 10 is a similar view to that shown in FIG. 8. As shown in FIG. 10, a fourth arm 104 has a first and a second extremity 106 and 108 respectively, the first extremity 106 of the fourth arm 104 being connected to the suspension 32 of the truck 12 on an opposite side of the truck 12 so that the proximity detector 24 and further proximity detector 102 are located on a first and a second side 110 and 112 respectively of the truck 12. A further portion 114 of the further proximity detector 102 is fixedly secured to the second extremity 108 of the fourth arm 104. The further portion 114 is disposed in a vicinity of the portion 100 such that when the truck 12 is loaded, the portion 100 and further portion 114 move towards each other and so that when the overloaded condition of the truck 12 is reached, the portion 100 and the further portion 114 are disposed adjacent to each other, the electrical circuit 36 is triggered. More specifically, when the portion 22 and the further portion 34 of the proximity detector 24 are disposed adjacent to each other and when the portion 100 and the further portion 114 of the further proximity detector 102 are disposed adjacent to each other, the electrical circuit 36 is triggered.. The arrangement is such that the circuit 36 is triggered regardless of a disposition of an overload relative to the sides 110 and 112 of the truck 12.

In operation of the apparatus 10, when the truck 12 is loaded, the weight of the load causes the truck suspension 32 to flex such that the respective portions of the proximity detectors 24 and 102 move towards each other and so that when such portions are adjacent to each other, the circuit 36 is actuated. The circuit is wired such that when either of the detectors 24 or 102 closes the circuit 36, the warning device is actuated providing the truck is parked. In this manner, if the overload is located above either side 110 or 112 of the truck or if the overload is centrally located, the warning device will be actuated.

The present invention provides a unique apparatus for deterring a customer from overloading a rental truck.

What is claimed is:

1. A detection apparatus for detecting an overloaded condition of a truck, said apparatus comprising:
a first arm having a first and a second end, said first end of said first arm being rigidly secured to a frame of the truck;
a portion of a proximity detector fixedly secured to said second end of said first arm;
a second arm having a first and a second extremity, said first extremity of said second arm being connected to a suspension of the truck;
a further portion of said proximity detector being fixedly secured to said second extremity of said second arm, said further portion being disposed in a vicinity of said portion such that when the truck is loaded, said portion and further portion move towards each other and so that when the overloaded condition of the truck is reached, said portion and said further portion are disposed adjacent to each other;
an electrical circuit triggered when said portion and said further portion are disposed adjacent to each other; and
a warning device electrically connected to said circuit such that when said circuit is triggered, said warning device is actuated.

2. A detection apparatus as set forth in claim 1 wherein
said first arm includes:
a first section which extend from said first end of said first arm;
a second section which extend from said first section to said second end of said first arm.

3. A detection apparatus as set forth in claim 2 wherein
said first section defines a hole;
said first arm including:
a fastener extending through said hole for fastening said first section to the frame of the truck.

4. A detection apparatus as set forth in claim 2 wherein
said second section supports said portion of said proximity detector.

5. A detection apparatus as set forth in claim 4 wherein
said portion of said proximity detector is welded to said second section.

6. A detection apparatus as set forth in claim 2 wherein
said second section extends angularly from said first section.

7. A detection apparatus as set forth in claim 1 wherein
said portion of said proximity detector includes:
a peripheral wall which is of circular configuration;
said wall being welded to said second end of said first arm.

8. A detection apparatus as set forth in claim 7 wherein
said wall includes:
a first weld;
a second weld disposed diametrically opposite to said first weld such that said welds secure said portion of said proximity detector to said second end of said first arm.

9. A detection apparatus as set forth in claim 1 wherein
said second arm includes:
a first member which extend from said first extremity of said second arm;
a second member which extend from said first member to said second extremity of said second arm.

10. A detection apparatus as set forth in claim 9 wherein
said first member defines a bore;
said second arm including:
a fastening device extending through said bore for connecting said first member to the suspension of the truck.

11. A detection apparatus as set forth in claim 9 wherein
said second member supports said further portion of said proximity detector.

12. A detection apparatus as set forth in claim 9 wherein
said further portion of said proximity detector is welded to said second member.

13. A detection apparatus as set forth in claim 9 wherein
said second member extends normal from said first member.

14. A detection apparatus as set forth in claim 1 wherein
said further portion of said proximity detector includes:
a peripheral casing which is of circular configuration;
said casing being welded to said second extremity of said second arm.

15. A detection apparatus as set forth in claim 14 wherein
said casing includes:
a first welding;
a second welding disposed diametrically opposite to said first welding such that said weldings secure said further portion of said proximity detector to said second extremity of said second arm.

16. A detection apparatus as set forth in claim 1 wherein
said proximity detector is a magnetic detector.

17. A detection apparatus as set forth in claim 1 further including:
a saddle bracket secured to said first extremity of said second arm;
said saddle bracket including:
a first part which cooperates with the suspension of the truck;
a second part which is fastened to said first part such that said parts extend around and are clamped to the suspension of the truck.

18. A detection apparatus as set forth in claim 1 further including:
a first magnetic device disposed within said portion of said proximity detector;
a second magnetic device disposed within said further portion of said proximity detector such that when said portion and said further portion are disposed adjacent to each other, said magnetic devices react relative to each other for triggering said electrical circuit.

19. A detection apparatus as set forth in claim 1 wherein
said warning device includes:
an audible alarm for deterring a user from overloading the truck.

20. A detection apparatus as set forth in claim 1 wherein
said warning device includes:
an visual alarm for deterring a user from overloading the truck.

21. A detection apparatus as set forth in claim 1 further including:
an inhibitor device electrically connected to said electrical circuit such that when said electrical circuit is triggered, said warning device is only electrically connected to said circuit when the truck is parked.

22. A detection apparatus as set forth in claim 1 further including:
a third arm having a first and a second end, said first end of said third arm being rigidly secured to the frame of the truck;
a portion of a further proximity detector fixedly secured to said second end of said third arm;
a fourth arm having a first and a second extremity, said first extremity of said fourth arm being connected to the suspension of the truck on an opposite side of the truck so that said proximity detector and further proximity detector are located on a first and a second side respectively of the truck;
a further portion of said further proximity detector being fixedly secured to said second extremity of said fourth arm, said further portion being disposed in a vicinity of said portion such that when the truck is loaded, said portion and further portion move towards each other and so that when the overloaded condition of the truck is reached, said portion and said further portion are disposed adjacent to each other;
said electrical circuit being triggered when said portion and said further portion of said proximity detector are disposed adjacent to each other and when said portion and said further portion of said further proximity detector are disposed adjacent to each other so that said circuit is triggered regardless of a disposition of an overload relative to the sides of the truck.

23. A detection apparatus for detecting an overloaded condition of a truck, said apparatus comprising:
a first arm having a first and a second end, said first end of said first arm being rigidly secured to a frame of the truck;
a portion of a proximity detector fixedly secured to said second end of said first arm;
a second arm having a first and a second extremity, said first extremity of said second arm being connected to a suspension of the truck;
a further portion of said proximity detector being fixedly secured to said second extremity of said second arm, said further portion being disposed in a vicinity of said portion such that when the truck is loaded, said portion and further portion move towards each other and so that when the overloaded condition of the truck is reached, said portion and said further portion are disposed adjacent to each other;
an electrical circuit triggered when said portion and said further portion are disposed adjacent to each other;
an audible warning device electrically connected to said circuit such that when said circuit is triggered, said warning device is actuated; and
said proximity detector being a magnetic detector.

24. A detection apparatus for detecting an overloaded condition of a truck, said apparatus comprising:
a first arm having a first and a second end, said first end of said first arm being rigidly secured to a frame of the truck;
a portion of a proximity detector fixedly secured to said second end of said first arm;
a second arm having a first and a second extremity, said first extremity of said second arm being connected to a suspension of the truck;
a further portion of said proximity detector being fixedly secured to said second extremity of said second arm, said further portion being disposed in a vicinity of said portion such that when the truck is loaded, said portion and further portion move towards each other and so that when the overloaded condition of the truck is reached, said portion and said further portion are disposed adjacent to each other;
an electrical circuit triggered when said portion and said further portion are disposed adjacent to each other;
a warning device electrically connected to said circuit such that when said circuit is triggered, said warning device is actuated;
said first arm including:
a first section which extend from said first end of said first arm;
a second section which extend from said first section to said second end of said first arm;
said first section defines a hole;
said first arm including:
a fastener extending through said hole for fastening said first section to the frame of the truck;
said second section supports said portion of said proximity detector;
said portion of said proximity detector being welded to said second section;
said second section extending angularly from said first section;
said portion of said proximity detector includes:
a peripheral wall which is of circular configuration;
said wall being welded to said second end of said first arm;
said wall including:
a first weld;
a second weld disposed diametrically opposite to said first weld such that said welds secure said portion of said proximity detector to said second end of said first arm;
said second arm includes:
a first member which extend from said first extremity of said second arm;
a second member which extend from said first member to said second extremity of said second arm;
said first member defining a bore;
said second arm including:
a fastening device extending through said bore for connecting said first member to the suspension of the truck;
said second member supporting said further portion of said proximity detector;
said further portion of said proximity detector is welded to said second member;
said second member extends normal from said first member;
said further portion of said proximity detector including:
a peripheral casing which is of circular configuration;
said casing being welded to said second extremity of said second arm;
said casing including:
a first welding;
a second welding disposed diametrically opposite to said first welding such that said weldings secure said further portion of said proximity detector to said second extremity of said second arm.
said proximity detector being a magnetic detector;
said apparatus further including:
a saddle bracket secured to said first extremity of said second arm;
said saddle bracket including:
a first part which cooperates with the suspension of the truck;
a second part which is fastened to said first part such that said parts extend around and are clamped to the suspension of the truck;
a first magnetic device disposed within said portion of said proximity detector;
a second magnetic device disposed within said further portion of said proximity detector such that when said portion and said further portion are disposed adjacent to each other, said magnetic devices react relative to each other for triggering said electrical circuit;
said warning device including:
an audible alarm for deterring a user from overloading the truck;
an inhibitor device electrically connected to said electrical circuit such that when said electrical circuit is triggered, said warning device is only electrically connected to said circuit when the truck is parked;
a third arm having a first and a second end, said first end of said third arm being rigidly secured to the frame of the truck;
a portion of a further proximity detector fixedly secured to said second end of said third arm;
a fourth arm having a first and a second extremity, said first extremity of said fourth arm being connected to the suspension of the truck on an opposite side of the truck so that said proximity detector and further proximity detector are located on a first and a second side respectively of the truck;
a further portion of said further proximity detector being fixedly secured to said second extremity of said fourth arm, said further portion being disposed in a vicinity of said portion such that when the truck is loaded, said portion and further portion move towards each other and so that when the overloaded condition of the truck is reached, said portion and said further portion are disposed adjacent to each other; and
said electrical circuit being triggered when said portion and said further portion of said proximity detector are disposed adjacent to each other and when said portion and said further portion of said further proximity detector are disposed adjacent to each other so that said circuit is triggered regardless of a disposition of an overload relative to the sides of the truck.
